(19) United States
(12) Patent Application Publication
(10) Pub. No.: US 2024/0169742 A1
(43) Pub. Date: May 23, 2024

(54) INFORMATION PROCESSING APPARATUS AND INFORMATION PROCESSING METHOD

(71) Applicant: TOYOTA JIDOSHA KABUSHIKI KAISHA, Toyota-shi Aichi-ken (JP)

(72) Inventor: Hideyuki TANAKA, Toyoake-shi Aichi-ken (JP)

(73) Assignee: TOYOTA JIDOSHA KABUSHIKI KAISHA, Toyota-shi Aichi-ken (JP)

(21) Appl. No.: 18/512,728

(22) Filed: Nov. 17, 2023

(30) Foreign Application Priority Data
Nov. 22, 2022 (JP) 2022-186169

(51) Int. Cl. G06V 20/58; G01C 21/36; G08G 1/01

(52) U.S. Cl. CPC G06V 20/58; G01C 21/3694; G08G 1/0112; G08G 1/0141

(57) ABSTRACT

An information processing apparatus is provided on a first vehicle that is a connected vehicle capable of performing V2X (Vehicle-to-Everything) communication. A controller of the information processing apparatus receives first information including location information of an obstacle. The controller outputs second information based on the first information. The second information is information to caution about the obstacle. When outputting the second information, the controller also outputs third information. The third information is information to indicate the existence of the obstacle.

### CROSS REFERENCE TO THE RELATED APPLICATION

This application claims the benefit of Japanese Patent Application No. 2022-186169, filed on Nov. 22, 2022, which is hereby incorporated by reference herein in its entirety.

### BACKGROUND

### Technical Field

The present disclosure relates to an information processing apparatus and an information processing method.

### Description of the Related Art

There is a known safe driving assistance apparatus provided on a vehicle that compares an image captured by the vehicle and an image captured by another vehicle using vehicle-to-vehicle communication to notify the driver of the vehicle of a possibility of collision (for example, see Patent Literature 1 in the citation list below).

### CITATION LIST

### Patent Literature

Patent Literature 1: Japanese Patent Application Laid-Open No. 2022-063508

### SUMMARY

An object of this disclosure is to provide a technology that makes it possible to prevent the driver from becoming distrustful of notifications related to driving assistance using V2X communication.

In one aspect of the present disclosure, there is provided an information processing apparatus provided on a first vehicle that is a connected vehicle capable of performing V2X (Vehicle-to-Everything) communication. For example, the information processing apparatus may comprise a controller including at least one processor that is configured to execute the processing of:
receiving first information including location information of a first object;
outputting second information based on the first information, the second information being information to caution about the first object; and
outputting third information based on the first information, the third information being information to indicate the existence of the first object.

In another aspect of the present disclosure, there is provided an information processing method implemented by a computer provided in a first vehicle that is a connected vehicle capable of performing V2X communication. For example, the computer may execute the processing of:
receiving first information including location information of a first object;
outputting second information based on the first information, the second information being information to caution about the first object; and
outputting third information based on the first information, the third information being information to indicate the existence of the first object.

According to other aspects, there are also provided an information processing program configured to cause a computer to implement the above-described information processing method and a non-transitory storage medium in which such an information processing program is stored.

According to the present disclosure, there is provided a technology that makes it possible to prevent the driver from becoming distrustful of notifications related to driving assistance using V2X communication.

### BRIEF DESCRIPTION OF THE DRAWINGS

FIG. 1 is a diagram the general configuration of a system according to an embodiment.

FIG. 2 is a diagram illustrating an example of the communication area of V2X communication.

FIG. 3 is a diagram illustrating an exemplary hardware configuration of an on-vehicle apparatus according to the embodiment.

FIG. 4 is a block diagram illustrating an exemplary functional configuration of the on-vehicle apparatus according to the embodiment.

FIG. 5 is a diagram illustrating a first example of a first coordinate system.

FIG. 6 is a diagram illustrating a second example of the first coordinate system.

FIG. 7 illustrates an example of a first screen.

FIG. 8 illustrates another example of the first screen.

FIG. 9 is a flow chart of a process executed in the on-vehicle apparatus according to the embodiment.

FIG. 10 is a diagram illustrating an exemplary configuration of a first vehicle according to a first modification.

FIG. 11 illustrates an example of a second screen.

FIG. 12 is a flow chart of a process executed in the on-vehicle apparatus according to the first modification.

### DESCRIPTION OF THE EMBODIMENTS

Communication technologies for vehicles such as V2X (Vehicle-to-Everything) communication have been developed in recent years. For example, when the airbag inflates in a connected vehicle capable of performing V2X communication, in other words when an accident occurs with the vehicle, it can transmit information (first information) including information on the accident location (i.e., the location of the vehicle) to other connected vehicles located around it. When a connected vehicle or a roadside apparatus detects a first object, such as a vehicle in accident, a service vehicle, a vehicle in trouble, or a fallen object, it can transmit information (first information) including information on the location of the first object to connected vehicles around it. Consequently, the connected vehicles that have received the first information mentioned above can notify the drivers of the information on the first object to alert them to the first object.

The first information mentioned above can be received by the connected vehicles that are located within the communication area of the V2X communication, that is, for example, within a radius of the order of several hundred meters to several kilometers from the connected vehicle that transmits the information at the center. Therefore, in some cases, the drivers of the connect vehicles may be notified of the above information on the first object that is located at a location that the drivers cannot see. For example, the communication area of V2X can include roads other than the road where the vehicle that transmits the first information is traveling. In consequence, drivers can be notified of the above information on the first object that is present in a road other than the road where they are traveling. In such cases, the drivers who are notified of the above information cannot visually recognize the first object. Such situations can make the drivers distrustful of the notification. Therefore, it is desired to prevent the drivers from becoming distrustful of the notifications as mentioned above.

In view of the above, when an information processing apparatus according to the present disclosure receives the first information including location information of a first object, the controller of the information processing apparatus is configured to output second information and third information based on the first information. The information processing apparatus according to the present disclosure is a computer provided in a connected vehicle (first vehicle) that is capable of performing V2X (Vehicle-to-Everything) communication. The first object is an object that is not normally present on the road, examples of which include a vehicle in accident, a vehicle in trouble, a service vehicle, and a fallen object. The second information according to the present disclosure is information to caution about the first object. The third information according to the present disclosure is information to indicate the existence of the first object. For example, the second information and the third information are output through a display or a speaker provided in the first vehicle.

The information processing apparatus according to the present disclosure can notify the driver of the first vehicle of the third information in addition to the second information. This allows the driver of the first vehicle to recognize that the first object actually exists even if he or she cannot visually recognize the first object. This also can reassure the driver of the first vehicle that the notification of the second information is not due to some malfunction of the apparatus. Therefore, the information processing apparatus according to the present disclosure can prevent the driver of the first vehicle from becoming distrustful of the notification of the second information under situations in which he or she cannot visually recognize the first object.

The first information may include image data (first image data) that is obtained by capturing an image of the first object in addition to the location information of the first object. In this case, the controller may output the first image data as the third information. The first image data is image data that is captured by the connected vehicle or the roadside apparatus that transmits the first information. When the first image data is output as the third information, the driver of the first vehicle can recognize that the first object actually exists.

The first information may include the date and time (first date and time) when the first image data was captured in addition to the location information of the first object and the first image data. In this case, the controller may output the first image data and the first date and time as the third information. This allows the driver of the first vehicle to recognize that the first object can actually exist at the time when she or he is notified of the information.

The first information may include second image data obtained by capturing an image of the first object and the road where the first object is located in addition to the location information of the first object. In this case, the controller may output the second image data as the third information. This allows the driver of the first vehicle to recognize that the first object actually exists. Moreover, the driver of the first vehicle can foresee whether the road where the first object is located is the same as the road where the first vehicle will travel.

The first information may further include information on the elevation (first elevation) of the place where the first object is located. In this case, the controller may determine the elevation (second elevation) of the place where the first vehicle is located when outputting the second information and the third information and output fourth information including the first elevation and the second elevation also. This allows the driver of the first vehicle to foresee whether the road where the first object is located is the same as the road where the first vehicle will travel. For example, the driver of the first vehicle can conjecture whether the layer of the road where the first object is located in a multi-layered road is the same as the layer of the road where the first vehicle is traveling.

In cases where the first vehicle according to the present disclosure is equipped with a navigation system, the controller may be configured to transmit a command signal to display the location of the first object on a map to the navigation system. Then, the driver of the first vehicle can view the map screen of the navigation system to know the location of the first object. In this way, the driver of the first vehicle can know the location of first object even when he or she cannot visually recognize the first object.

As described above, the information processing apparatus according to the present disclosure can receive the first information that is transmitted from another connected vehicle or a roadside apparatus that is located in the area within a radius of the order of several hundred meters to several kilometers from the first vehicle at the center (namely, in the communication area of V2X communication). Therefore, there may be cases where the information processing apparatus according to the present disclosure receives the first information about a first object that is located behind the first vehicle as it is traveling. The first object that is located behind the first vehicle will have little effect on the travel of the first vehicle. It can make the driver of the first vehicle inconvenienced for the information processing apparatus to output the second information and the third information related to the first object that is located behind the first vehicle.

The controller of the information processing apparatus according to the present disclosure may be configured to determine whether the first object is located in the traveling direction of the first vehicle as it is traveling when the first information is received. The controller may output the second information and the third information on condition that the first object is located in the traveling direction of the first vehicle as it is traveling. In this way, it is possible to make the driver of the first vehicle recognize that the first object can exist actually without making him/her inconvenienced.

In another aspect of the present disclosure, the technology disclosed herein can be identified as an information processing method that is implemented by a computer that performs the processing of the information processing apparatus described above. The information processing method can accomplish the effects same as the information processing apparatus described above. In still another aspect of the present disclosure, the technology disclosed herein can also be identified as a program configured to cause a computer to perform the processing of the information processing apparatus described above or a non-transitory storage medium that stores such a program.

In the following, a specific embodiment of the technology disclosed herein will be described with reference to the drawings. It should be understood that hardware configurations, module configurations, and functional configurations that will be described in the following description of the embodiment are not intended to limit the technical scope of the disclosure only to them, unless otherwise stated.

### Embodiment

In the following description of the embodiment, a case where the information processing apparatus according to the present disclosure is applied to a system that provides driving assistance for connected vehicles using V2X communication will be described.

### General Configuration of System

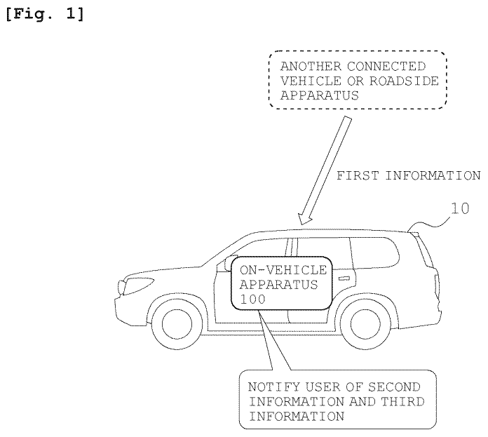

FIG. 1 is a diagram illustrating the general configuration of a system according to the embodiment. The system according to the embodiment includes a first vehicle 10 and an on-vehicle apparatus 100. The first vehicle 10 is a connected vehicle driven by a user (driver) to whom driving assistance is provided. The on-vehicle apparatus 100 is a computer provided in the first vehicle 10, which is an example of the information processing apparatus according to the present disclosure.

The on-vehicle apparatus 100 receives first information using V2X communication. The first information according to the embodiment is information on an obstacle on the road. The term “obstacle” as used in the description of the embodiment refers to an object that is not normally present on the road. Examples of the obstacle include a vehicle in accident (or a vehicle in which the airbag has inflated), a vehicle in trouble, a service vehicle, and a fallen object (including a part dropped or scattered from the vehicle). Such obstacles are examples of the “first object” according to the present disclosure.

The first information according to the embodiment is information including location information of an obstacle, image data of the obstacle and information on the date and time when the image data of the obstacle was obtained. The first information is transmitted from an on-vehicle apparatus provided on a connected vehicle other than the first vehicle or a roadside apparatus by broadcast. Examples of the aforementioned connected vehicle other than the first vehicle include a vehicle in accident, a vehicle that has detected a vehicle in accident, a vehicle in trouble, a vehicle that has detected a vehicle in trouble, a service vehicle, and a vehicle that has detected a service vehicle. The image data of the obstacle is image data captured by the connected vehicle or the roadside apparatus that transmits the first information. The image data of the obstacle may be either image data obtained by capturing only the obstacle (which corresponds to the “first image data” according to the present disclosure) or image data obtained by capturing the obstacle together with the road where the obstacle is located (which corresponds to the “second image data” according to the present disclosure. In the description of the embodiment, a case where the second image data is used as the image data of the obstacle is described.

When the on-vehicle apparatus 100 receives the first information, it notifies the user of the first vehicle 10 of information (second information) to alert the user to the obstacle. This allows the user of the first vehicle 10 to prepare for driving maneuver to avoid a collision with the obstacle or other accidents. The on-vehicle apparatus 100 can receive the first information transmitted from other connected vehicles and roadside apparatuses located within the communication area of V2X communication (e.g., an area within a radius of the order of several hundred meters to several kilometers from the first vehicle 10 at the center).

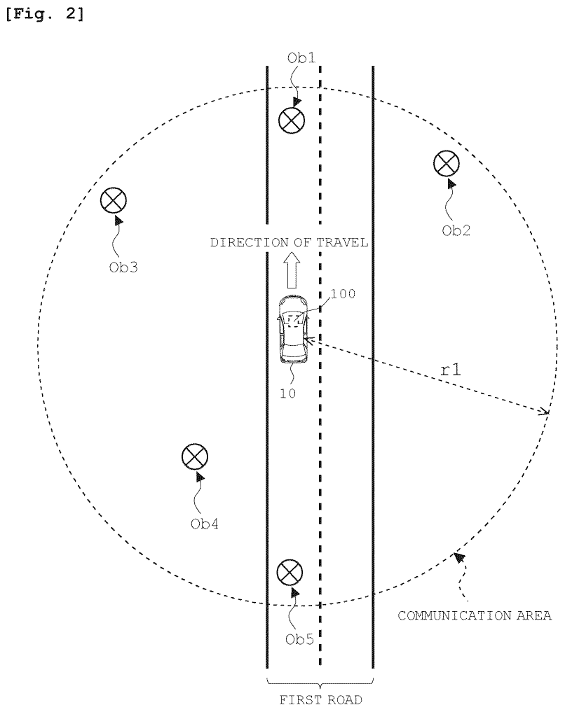

An example of the area from which the on-vehicle apparatus 100 can receive the first information will be described with reference to FIG. 2. As illustrated in FIG. 2, the on-vehicle apparatus 100 can receive the first information from other connected vehicles and roadside apparatuses that are located in a circular area (communication area of V2X) within a radius of r1 (e.g., of the order of several hundred meters to several kilometers) from the first vehicle 10 at the center of the circle. Therefore, the on-vehicle apparatus 100 can receive not only the first information related to obstacles Ob1, Ob5 located on the road where the first vehicle 10 is traveling (i.e., the “first road” in FIG. 2) but also the first information related to obstacles Ob2, Ob3, Ob4 that are located outside the first road. The “outside” of the first road includes other roads that are located near the first road, examples of which include side roads and by-paths.

Among the first through fifth obstacles Ob1-Ob5 illustrated in FIG. 2, the second, third, and fourth obstacles Ob2, Ob3, Ob4 are unlikely to be visually recognizable from the first vehicle 10. Therefore, if the user of the first vehicle 10 is notified of the second information related to the second, third, fourth obstacles Ob2, Ob3, Ob4, there is a possibility that the user suspects that the notification is due to a malfunction of the on-vehicle apparatus 100. Moreover, the fourth and fifth obstacles Ob4, Ob5 located behind the first vehicle 10 as it is traveling are considered to have very little effect on the travel of the first vehicle 10. Therefore, if the user of the first vehicle 10 is notified of the second information related to the fourth or fifth obstacle Ob4, Ob5, there is a possibility that the user feels inconvenienced.

In view of the above, the on-vehicle apparatus 100 according to the embodiment is configured to notify the user of the second information only in the case where the obstacle Ob to which the first information is related is located in the traveling direction of the first vehicle 10 as it is traveling (e.g. obstacles Ob1, Ob2, and Ob3 in FIG. 2). Moreover, the on-vehicle apparatus 100 according to the embodiment is configured to notify the user of the third information also together with the second information. The third information is information that indicates the actual existence of the obstacle to which the first information is related. The third information used in this embodiment includes second image data (i.e., image data obtained by capturing obstacle and the road where the obstacle is located) and the date and time when the second image data was captured. Since the user of the first vehicle 10 is not notified of the second information related to the obstacles Ob located behind the first vehicle 10 as above, it is possible to prevent the user from feeling inconvenienced. Providing the third information to supplement the second information can prevent the user of the first vehicle 10 from feeling distrustful of the notification of the second information even when the user is notified of the second information related to an obstacle that he or she cannot visually recognize.

### Hardware Configuration of On-Vehicle Apparatus

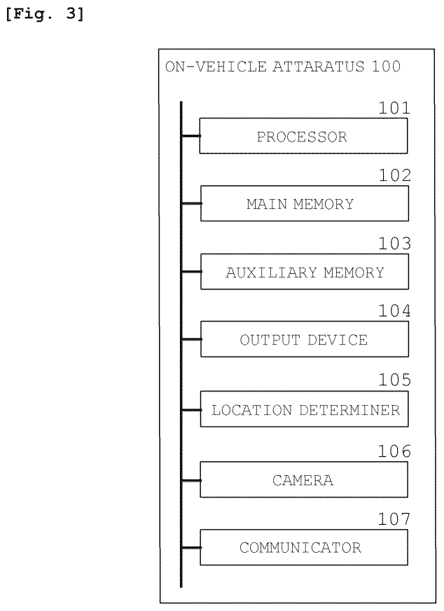

FIG. 3 is a diagram illustrating an example of the hardware configuration of the on-vehicle apparatus 100 according to the embodiment. As illustrated in FIG. 3, the on-vehicle apparatus 100 according to the embodiment has a processor 101, a main memory 102, an auxiliary memory 103, an output device 104, a location determiner 105, a camera 106, and a communicator 107. While FIG. 3 illustrates only hardware components that are related to driving assistance using V2X, the on-vehicle apparatus 100 may include other hardware components also.

The processor 101 is an arithmetic processing unit such as a CPU (Central Processing Unit) or a DSP (Digital Signal Processor). The processor 101 loads programs stored in the auxiliary memory 103 into the main memory 102 and executes them to control the on-vehicle apparatus 100.

The main memory 102 includes a semiconductor memory, such as a RAM (Random Access Memory) and a ROM (Read Only Memory). The main memory 102 provides a storage area and a work area into which programs stored in the auxiliary memory 103 are loaded. The main memory 102 is also used as a buffer for the arithmetic processing executed by the processor 101.

For example, the auxiliary memory 103 includes an EPROM (Erasable Programmable ROM) or an HDD (Hard Disk Drive). The auxiliary memory 103 may include a removable medium or a portable recording medium. Examples of the removable medium include a USB (Universal Serial Bus) memory and a disc recording medium, such as a CD (Compact Disc) or a DVD (Digital Versatile Disc). The auxiliary memory 103 stores various programs and data that the processor 101 uses when executing the programs.

The programs stored in the auxiliary memory 103 include an operating system (OS) and a special application program for causing the processor 101 to execute processing related to driving assistance using V2X.

The output device 104 is a device that presents information to the user of the first vehicle 10. The output device 104 used in the system according to the embodiment includes a display and a speaker. The display may be a multi-information display (MID) or a display of a navigation system with which the first vehicle 10 is equipped.

The location determiner 105 is a device that determines the present location of the first vehicle 10. The location determiner 105 used in the system according to the embodiment determines the present location of the first vehicle 10. For example, the location determiner 105 is a GPS (Global Positioning System) receiver. The location determiner 105 is not limited to a GPS receiver. For example, the location determiner 105 may be a wireless communication circuit that uses a location information service based on Wi-Fi (registered trademark) access points. For example, the location information determined by the location determiner 105 is geographical coordinates, such as the latitude and longitude.

The camera 106 captures images of the surroundings of the first vehicle 10. The camera 106 may be either a special camera or a camera of a drive recorder or an advanced safety system.

The communicator 107 is a device used to perform V2X communication. The communicator 107 used in the system according to the embodiment performs V2X communication using short range communication (communication through distances of the order of f several hundred meters to several kilometers). For example, the communicator 107 performs V2X communication using wireless communication based on a communication standard as such Bluetooth (registered trademark) Low Energy (BLE), NFC (Near Field Communication), UWB (Ultra Wideband), DSRC (Dedicated Short-Range Communications), or Wi-Fi (registered trademark).

### Functional Configuration of On-Vehicle Apparatus

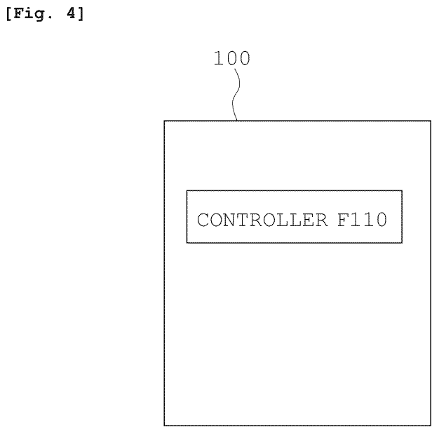

The functional configuration of the on-vehicle apparatus 100 according to the embodiment will now be described with reference to FIG. 4. As illustrated in FIG. 4, the on-vehicle apparatus 100 has a controller F110 as its functional component. The functional configuration of the on-vehicle apparatus 100 is not limited to that illustrated in FIG. 4, but some components may be added or the controller F110 may be replaced by other functional component.

The controller F110 is implemented by the processor 101 of the on-vehicle apparatus 100 by loading a special program stored in the auxiliary memory 103 into the main memory 102 and executing it. Alternatively, the controller F110 may be implemented by a hardware circuit, such as an ASIC (Application Specific Integrated Circuit) or an FPGA (Field Programmable Gate Array).

The controller F110 receives first information transmitted from another vehicle or a roadside apparatus that is located within the communication area of V2X communication (e.g., a circular area within a radius of r1 from the first vehicle 10 at the center of the circle) through the communicator 107. The first information according to the embodiment includes location information of an obstacle Ob, the second image data (image data obtained by capturing the obstacle Ob and the road where the obstacle Ob is located), and date and time when the second image data was captured. For example, the location information of the obstacle is geographical coordinates of the obstacle, such as the latitude and longitude. The first information may include information indicating the type of the obstacle. Examples of the type of obstacle include vehicle in accident, vehicle in trouble, service vehicle, and fallen object. For example, the type of the obstacle may be determined by image recognition processing performed on the second image data by the other vehicle or the roadside apparatus that has detected the obstacle. Alternatively, the controller F110 of the first vehicle 10 may determine the type of the obstacle by performing image recognition processing on the second image data included in the first information.

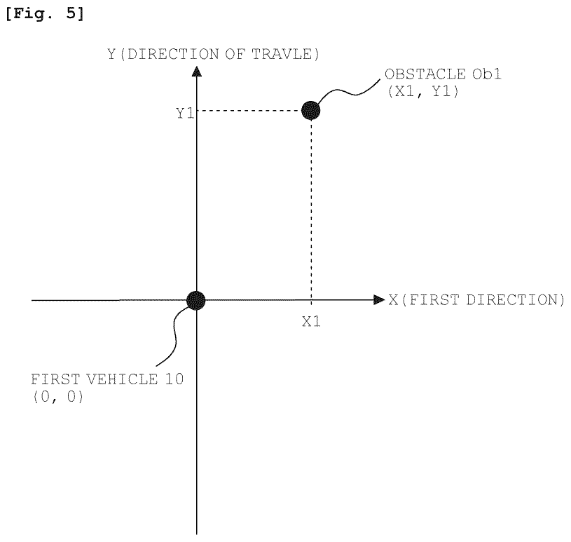

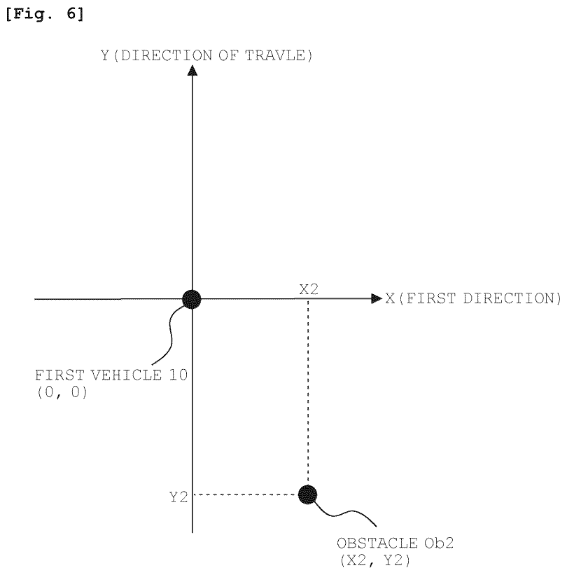

The controller F110 determines whether the obstacle Ob is located in the traveling direction of the first vehicle 10 as it is traveling based on the location information included in the first information and the present location of the first vehicle. A method of determining whether the obstacle Ob is located in the traveling direction of the first vehicle 10 as it is traveling will be described here with reference to FIGS. 5 and 6. FIGS. 5 and 6 illustrate an orthogonal coordinate system having its origin set at the present location of the first vehicle 10, which will also be referred to as the “first coordinate system” hereinafter. The Y axis in FIGS. 5 and 6 represents the distance from the first vehicle 10 along the direction of travel of the first vehicle 10. The X axis in FIGS. 5 and 6 represents the distance from the first vehicle 10 along a direction that is horizontal and perpendicular to the direction of travel of the first vehicle 10, which will also be referred to as the “first direction” hereinafter.

When the communicator 107 of the on-vehicle apparatus 100 receives the first information, the controller F110 obtains the present location (i.e., the geographical coordinates) of the first vehicle 10 through the location determiner 105. The controller F110 converts the geographical coordinate system including the location information in the first information and the present location of the first vehicle 10 into coordinates in the first coordinate system illustrated in FIGS. 5 and 6. The controller F110 determines the Y coordinate of the obstacle Ob in the first coordinate system (namely, Y1 in FIG. 5 or Y2 in FIG. 6).

The controller F110 determines whether the obstacle Ob is located in the traveling direction of the first vehicle 10 as it is traveling based on the sign (positive/negative) of the Y coordinate (Y1 or Y2) of the obstacle Ob in the first coordinate system. When the obstacle Ob is located in the traveling direction of the first vehicle 10 as it is traveling as illustrated in FIG. 5, the Y coordinate (Y1) of the obstacle Ob in the first coordinate system has a positive value. When the obstacle Ob is located behind the first vehicle 10 as it is traveling as illustrated in FIG. 6, the Y coordinate (Y2) of the obstacle Ob in the first coordinate system has a negative value. Therefore, when the Y coordinate of the obstacle Ob in the first coordinate system has a positive value, the controller F110 according to the embodiment determines that the obstacle Ob is located in the traveling direction of the first vehicle 10 as it is traveling. When the Y coordinate of the obstacle Ob in the first coordinate system has a negative value, the controller F110 according to the embodiment determines that the obstacle Ob is located behind the first vehicle 10 as it is traveling.

When it is determined that the obstacle Ob to which the first information is related is located in the traveling direction of the first vehicle 10 as it is traveling, the controller F110 causes the output device 104 to output the second information. Specifically, the controller F110 may display the second information as textual information on the display of the output device 104 or output the second information as voice information through the speaker of the output device 104. In the case where the second information is displayed as textual information on the display of the output device 104, a notification tone may also be output through the speaker of the output device 104 to call the user's attention.

When it is determined that the obstacle Ob to which the first information is related is located in the traveling direction of the first vehicle 10 as it is traveling, the controller F110 causes the output device 104 to output the third information in addition to the second information. Specifically, the controller F110 outputs the second image data included in the first information through the display of the output device 104. Moreover, the controller F110 creates textual data or voice data that indicates the date and time when the second image data was captured based on the information on the date and time of image-capturing and outputs the textual data or voice data created as above through the display or the speaker of the output device 104.

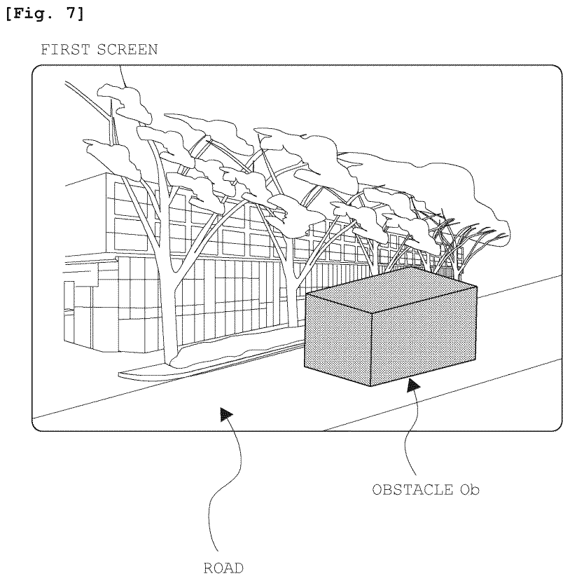

FIG. 7 illustrates an example of the screen that displays the second image data. This screen will also be referred to as the “first screen” hereinafter. In the case illustrated in FIG. 7, image data of an obstacle Ob and the road where the obstacle Ob is located is displayed. As this first screen is displayed on the display of the output device 104, the user of the first vehicle 10 can recognize that the obstacle Ob can actually exist, in other words, that the reliability of the second information is high. Moreover, the user of the first vehicle 10 who sees the image of the road where the obstacle Ob is located can foresee whether the road where the first vehicle 10 will travel is the same as the road where the obstacle Ob is located. The user of the first vehicle 10 can also conjecture whether the obstacle Ob still exists based on the date and time of image-capturing output through the output device 104.

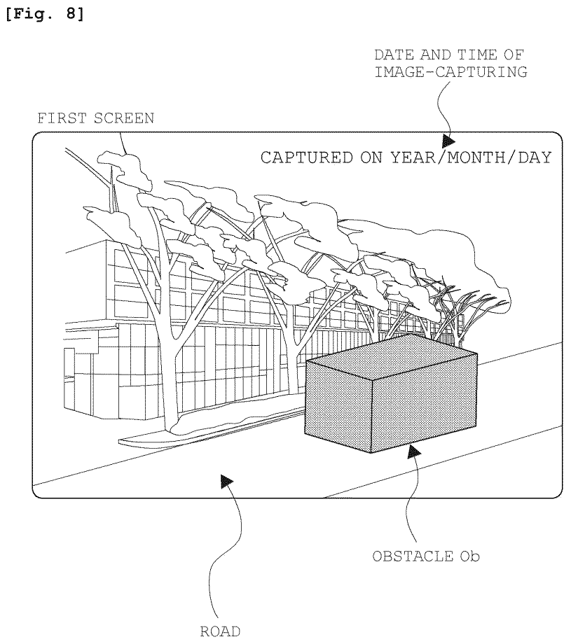

The information on the date and time of capturing of the second image data may be output as textual data indicating the date and time that is superimposed on the second image data. FIG. 8 illustrates another example of the first screen. The first screen illustrated in FIG. 8 displays the second image data and textual data indicating the date and time of image-capturing that is superimposed on the second image data. As the first screen illustrated in FIG. 8 is displayed on the display of the output device 104, the user of the first vehicle 10 who sees the first screen can view the image of the obstacle Ob, the image of the road, and the date and time of image-capturing at once.

### Process Performed in On-Vehicle Apparatus

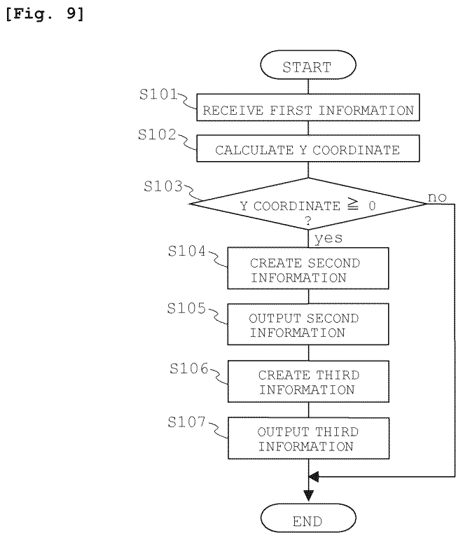

A process performed in the on-vehicle apparatus 100 according to the embodiment will be described with reference to FIG. 9. FIG. 9 is a flow chart of a processing routine executed in the on-vehicle apparatus 100, which is triggered by the reception of the first information by the communicator 107 of the on-vehicle apparatus 100. While the processing routine according to the flow chart of FIG. 9 is executed by the processor 101 of the on-vehicle apparatus 100, a functional component (the controller F110) of the on-vehicle apparatus 100 will be mentioned in the following description as the component that executes the processing in the routine.

In the processing routine according to the flow chart of FIG. 9, when the communicator 107 of the on-vehicle apparatus 100 receives the first information, the first information is transferred from the communicator 107 to the controller F110. Thus, the controller F110 receives the first information through the communication part 107 (step S101). After completing the processing of step S101, the controller F110 executes the processing of step S102.

In step S102, the controller F110 calculates the Y coordinate of the obstacle Ob in the first coordinate system. Specifically, the controller F110 obtains the present location of the first vehicle 10 through the location determiner 105. The controller F110 converts the geographical coordinate system including the location information included in the first information and the present location of the first vehicle 10 into coordinates in the first coordinate system illustrated in FIGS. 5 and 6. The controller F110 calculates the Y coordinate (Y1 or Y2) of the obstacle Ob in the first coordinate system. After completing the processing of step S102, the controller F110 executes the processing of step S103.

In step S103, the controller F110 determines whether or not the Y coordinate calculated in step S102 is not less than 0 (zero). When the Y coordinate calculated in step S102 is smaller than 0 (negative answer in step S103), the obstacle Ob is located behind the traveling first vehicle 10. Then, the controller F110 terminates execution of this processing routine. In consequence, the notification of the second information and the third information is not performed for this obstacle Ob. When the Y coordinate calculated in step S102 is not less than 0 (affirmative answer in step S103), the obstacle Ob is located in the traveling direction of the first vehicle 10. Then, the controller F110 executes the processing of step S104 onward.

In step S104, the controller F110 creates the second information. The second information is information to alert the user to the obstacle Ob. The second information is information to alert the user to the obstacle Ob that is present around the road where the first vehicle 10 will travel. After completing the processing of step S104, the controller F110 executes the processing of step S105.

In step S105, the controller F110 outputs the second information created in step S104 through the output device 104. Thus, it is possible to notify the user of the presence of the obstacle Ob located around the road where the first vehicle 10 will travel and to prompt the user to prepare for driving maneuver to avoid the obstacle Ob. After completing the processing of step S105, the controller F110 executes the processing of step S106.

In step S106, the controller F110 creates the third information. The third information created in the system according to the embodiment is the second image data included in the first information (see FIG. 7) or the image data created by superimposing textual data indicating the date and time of image-capturing on the second image data (see FIG. 8). After completing the processing of step S106, the controller F110 executes the processing of step S107.

In step S107, the controller F110 outputs the third information created in step S106 through the display of the output device 104. After completing the processing of step S107, the controller F110 terminates execution of this processing routine.

### Operation and Effects of System According to Embodiment

When the on-vehicle apparatus 100 according to the embodiment described above receives the first information related to an obstacle Ob, it can notify the user of the first vehicle 10 of the third information that indicates the actual existence of the obstacle Ob in addition to the second information that alerts the user to the obstacle Ob. Therefore, even in the case where the user is notified of the second information related to an obstacle Ob that the user cannot recognize visually, the user of the first vehicle 10 can recognize the actual existence of the obstacle Ob. As the second image data obtained by capturing an image of the obstacle Ob and the road where the obstacle Ob is located is used as the third information, the user of the first vehicle 10 can foresee whether the road where the first vehicle 10 will travel is the same as the road where the obstacle Ob is located. Moreover, as the third information includes information indicating the date and time when the second image data was captured, the user of the first vehicle 10 can conjecture whether the object Ob still exists.

As above, the system according to the embodiment can alert the user to the obstacle Ob while preventing the user from becoming distrustful of the second information.

### First Modification

When the on-vehicle apparatus 100 in the system according to the first embodiment described above receives the first information, it notifies the user of the first vehicle 10 of the second information and the third information. The on-vehicle apparatus 100 according to the first modification described in the following is configured not only to notify the user of the second and third information but also to display the location of the obstacle Ob on the map screen of the navigation system, when the on-vehicle apparatus 100 receives the first information.

When the first vehicle 10 is traveling in an area unfamiliar to the user, although the user who sees the second image data can recognize the actual existence of the obstacle Ob, it may sometimes be difficult for the user to foresee whether the road where the first vehicle 10 will travel and the road where the obstacle Ob is located are the same road. If the location of the obstacle Ob is displayed on the map screen of the navigation system, the user can easily foresee whether the road where the first vehicle 10 will travel and the road where the obstacle Ob is located are the same.

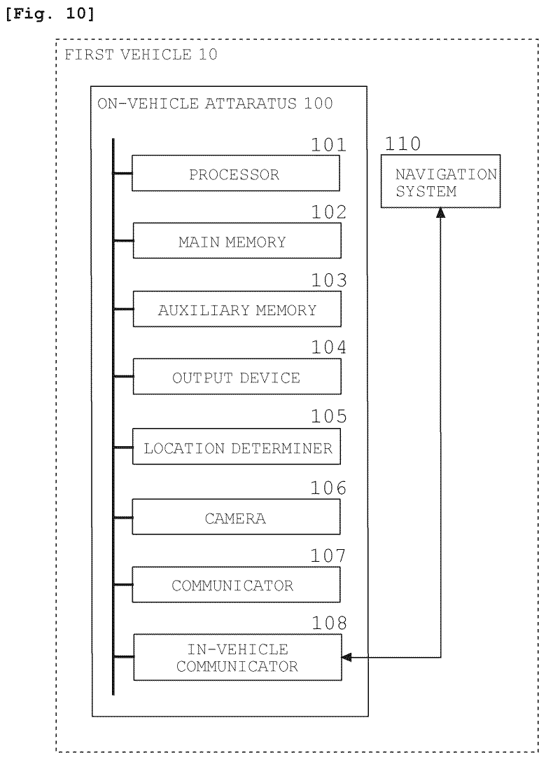

FIG. 10 is a diagram illustrating an example of the configuration of the first vehicle 10 according to the first modification. The first vehicle 10 according to the first modification has an on-vehicle apparatus 100 and a navigation system 110.

As illustrated in FIG. 10, the on-vehicle apparatus 100 according to the first modification has a processor 101, a main memory 102, an auxiliary memory 103, an output device 104, a location determiner 105, a camera 106, a communicator 107, and an in-vehicle communicator 108. The processor 101, the main memory 102, the auxiliary memory 103, the output device 104, the location determiner 105, the camera 106, and the communicator 107 are the same as the corresponding components in the on-vehicle apparatus 100 according to the embodiment described above and will not be described in further detail. The in-vehicle communicator 108 is an interface used to communicate with the navigation system 110 through an in-vehicle network. The in-vehicle network is a network based on CAN (Controller Area Network), LIN (Local Interconnect Network), FlexRay, or other standard.

The navigation system 110 is a system that provides route guidance to the user of the first vehicle 10 by displaying the present location of the first vehicle 10 and the route along which the first vehicle 10 will travel on the map screen. The navigation system 110 will not be described in detail, because a known navigation system can be used as the navigation system 110.

The functional configuration of the on-vehicle apparatus 100 in the system of this modification is the same as that in the system according to the embodiment described above (see FIG. 4).

When the communicator 107 of the on-vehicle apparatus 100 receives the first information, the controller F110 creates and outputs the second information and the third information and in addition sends a display command to the navigation system 110. The display command is a signal including the location information of the obstacle Ob and a command to display the location of the obstacle Ob on the map screen of the navigation system 110. The display command is transmitted from the on-vehicle apparatus 100 to the navigation system 110 through the in-vehicle communicator 108.

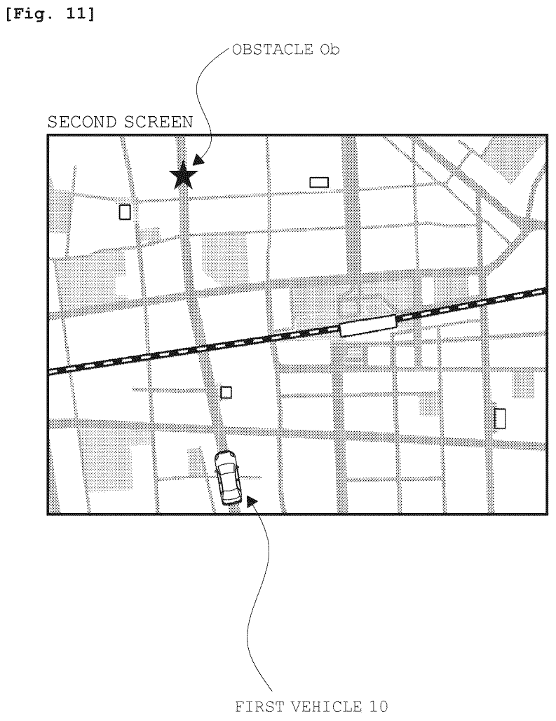

The navigation system 110 receives the display command. Then, the navigation system determines the location of the obstacle Ob on the map based on the location information of the obstacle Ob included in the display command and displays a figure representing the obstacle Ob at the location of the obstacle Ob thus determined. FIG. 11 illustrates an example of the screen displayed by the navigation system 110 that has received the display command. This screen will also be referred to as the “second screen” hereinafter. The second screen displays the map of the area around the present location of the first vehicle 10 and a figure indicating the location of the obstacle Ob (namely, the star in FIG. 11). As this second screen is displayed on the navigation system 110, the user of the first vehicle 10 can foresee whether the road where the first vehicle 10 will travel and the road where the obstacle Ob is located are the same road, even when the first vehicle is traveling in an area unfamiliar to the user of the first vehicle.

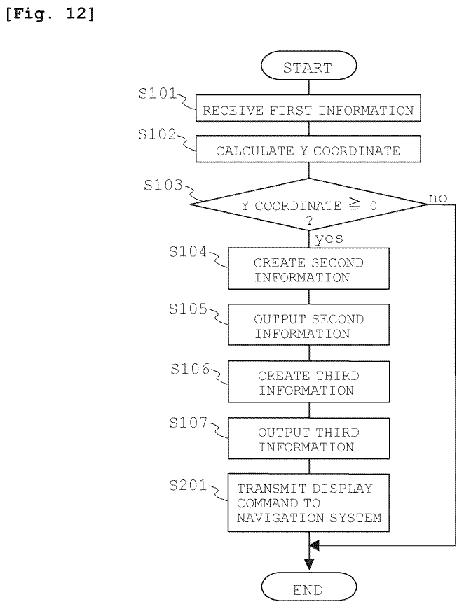

A process performed in the on-vehicle apparatus 100 according to this modification will be described with reference to FIG. 12. FIG. 12 is a flow chart of a processing routine executed in the on-vehicle apparatus 100, which is triggered by the reception of the first information by the communicator 107 of the on-vehicle apparatus 100. In FIG. 12, the steps of processing the same as the steps of processing in the processing routine according to the flow chart of FIG. 9 are denoted by the same reference signs.

In the process according to the flow chart of FIG. 12, after completing the processing of step S107, the controller F110 executes the processing of step S201. In step S201, the controller F110 transmits the display command including the location information included in the first information and a command to display the location of the obstacle Ob on the map screen of the navigation system 110 to the navigation system 110 through the in-vehicle communicator 108. After completing the processing of step S201, the controller F110 terminates execution of this processing routine.

When the processing routine according to the flow chart of FIG. 12 is executed in the on-vehicle apparatus 100, the navigation system 110 receives the display command transmitted from the on-vehicle apparatus 100 and displays the second screen as illustrated in FIG. 11. With this feature, the system of this modification can accomplish the effect that the user of the first vehicle 10 can easily foresee whether the road where the first vehicle 10 will travel and the road where the obstacle Ob is located are the same road in addition to the effects the same as the system according the embodiment described above. In this way, the system of this modification can appropriately alert the user of the first vehicle 10 to the obstacle Ob.

### Second Modification

When the on-vehicle apparatus 100 in the system according to the first embodiment described above receives the first information, it notifies the user of the first vehicle 10 of the second information third information. The on-vehicle apparatus 100 according to the second modification described in the following is configured to notify the user of the fourth information in addition to the second and third information.

The fourth information according to the second modification includes information on the elevation (first elevation) of the place where the obstacle Ob is located and information on the elevation (second elevation) of the place where the first vehicle 10 is located. The information on the first elevation is included in the first information. The second elevation is determined using a sensor (e.g., a barometer or an altimeter) provided in the first vehicle 10. The on-vehicle apparatus 100 may notify the user of the fourth information by displaying textual data on the display of the output device 104 or outputting voice data through the speaker of the output device 104.

The system according to the second modification allows the user of the first vehicle 10 to easily conjecture whether the layer of the road where the obstacle Ob is located and the layer of the road where the first vehicle 10 is traveling are the same layer in a multilayered road.

### Others

The above embodiment has been described only by way of example. The technology disclosed herein can be implemented in modified manners without departing from the essence of this disclosure. For example, features of the embodiment and the modification described above may be adopted in desired combinations, if it is technically feasible to do so.

One or some of the processes that have been described as processes performed by one apparatus may be performed by a plurality of apparatuses in a distributed manner. One or some of the processes that have been described as processes performed by different apparatuses may be performed by one apparatus. The hardware configuration used to implement various functions in a computer system may be modified flexibly.

The technology disclosed herein can be implemented by supplying a computer program (information processing program) or programs configured to implement the functions described in the above description of the embodiment to a computer to cause one or more processors of the computer to read out and execute the program or programs. Such a computer program or programs may be supplied to the computer by a non-transitory, computer-readable storage medium that can be connected to a system bus of the computer or through a network. The non-transitory, computer-readable storage medium is a recording medium that can store information such as data and programs electrically, magnetically, optically, mechanically, or chemically in a computer-readable manner. Examples of such a recording medium include any type of discs including magnetic discs, such as a floppy disc (registered trademark) and a hard disk drive (HDD), and optical discs, such as a CD-ROM, a DVD, and a Blu-ray disc. The non-transitory, computer-readable storage medium may also be a ROM, a RAM, an EPROM, an EEPROM, a magnetic card, a flash memory, an optical card, an SSD (Solid State Drive), or other medium.

What is claimed is:

1. An information processing apparatus provided on a first vehicle that is a connected vehicle capable of performing V2X (Vehicle-to-Everything) communication, comprising a controller including at least one processor, the controller being configured to execute the processing of:
receiving first information including location information of a first object;
outputting second information based on the first information, the second information being information to caution about the first object; and
outputting third information based on the first information, the third information being information to indicate the existence of the first object.

2. The information processing apparatus according to claim 1, wherein
the first information further includes first image data, the first image data being image data obtained by capturing an image of the first object, and
the controller outputs the first image data as the third information.

3. The information processing apparatus according to claim 2, wherein
the first information further includes information on first date and time, which is the date and time when the first image data was captured, and
the controller outputs the first image data and the first date and time as the third information.

4. The information processing apparatus according to claim 1, wherein
the first information further includes second image data, the second image data being image data obtained by capturing an image of the first object and a road where the first object is located, and
the controller outputs the second image data as the third information.

5. The information processing apparatus according to claim 1, wherein
the first information includes information on a first elevation, the first elevation being an elevation of a place where the first object is located, and
the controller is configured to further execute the processing of outputting fourth information including the first elevation and a second elevation when outputting the second information and the third information, the second elevation being an elevation of the place where the first vehicle is located.

6. The information processing apparatus according to claim 1, wherein
the first vehicle is provided with a navigation system, and
the controller is configured to further execute the processing of transmitting a command signal to display the location of the first object on a map based on the first information to the navigation system.

7. The information processing apparatus according to claim 1, wherein the controller is configured to further execute the processing of:
determining whether the first object is located in a traveling direction of the first vehicle; and
outputting the second information and the third information on condition that it is determined that the first object is located in the traveling direction of the first vehicle.

8. The information processing apparatus according to claim 1, wherein the first object is a vehicle in accident, a vehicle in trouble, a service vehicle, or a fallen object.

9. An information processing method comprising the following processing executed by a computer provided in a first vehicle that is a connected vehicle capable of performing V2X (Vehicle-to-Everything) communication:
receiving first information including location information of a first object;
outputting second information based on the first information, the second information being information to caution about the first object; and
outputting third information based on the first information, the third information being information to indicate the existence of the first object.

10. The information processing method according to claim 9, wherein
the first information further includes first image data, the first image data being image data obtained by capturing an image of the first object, and
the computer outputs the first image data as the third information.

11. The information processing method according to claim 10, wherein
the first information further includes information on first date and time, which is the date and time when the first image data was captured, and
the computer outputs the first image data and the first date and time as the third information.

12. The information processing method according to claim 9, wherein
the first information further includes second image data, the second image data being image data obtained by capturing an image of the first object and a road where the first object is located, and
the computer outputs the second image data as the third information.

13. The information processing method according to claim 9, wherein
the first information includes information on a first elevation, the first elevation being an elevation of a place where the first object is located, and
the computer is configured to further execute the processing of outputting fourth information including the first elevation and a second elevation when outputting the second information and the third information, the second elevation being an elevation of the place where the first vehicle is located.

14. The information processing method according to claim 9, wherein
the first vehicle is provided with a navigation system, and
the computer is configured to further execute the processing of transmitting a command signal to display the location of the first object on a map based on the first information to the navigation system.

15. The information processing method according to claim 9, wherein the computer further executes the processing of:
determining whether the first object is located in a traveling direction of the first vehicle; and
outputting the second information and the third information on condition that it is determined that the first object is located in the traveling direction of the first vehicle.

16. The information processing method according to claim 9, wherein the first object is a vehicle in accident, a vehicle in trouble, a service vehicle, or a fallen object.
